(19) United States
(12) Patent Application Publication
(10) Pub. No.: US 2025/0199891 A1
(43) Pub. Date: Jun. 19, 2025

(54) SOFTWARE APPLICATION ACCESS

(71) Applicant: Grammarly, Inc., San Francisco, CA (US)

(72) Inventors: Rob Brazier, Alamo, CA (US); Daniel Lin, San Bruno, CA (US); Elise Fung, Los Altos Hills, CA (US)

(21) Appl. No.: 18/541,341

(22) Filed: Dec. 15, 2023

(51) Int. Cl. G06F 9/54; G06F 9/451

(52) U.S. Cl. CPC G06F 9/547; G06F 9/451

(57) ABSTRACT

A computer-implemented method executed using an assistant application and a web browser hosted or executed using a first computer, the computer-implemented method comprising receiving a first signal that first application is executing, with text within a workspace of the first application; receiving a second signal that a control was selected; instantiating and causing displaying an app actions window comprising at least one app label respectively corresponding to at least one second application; receiving input from the first computer specifying a selection of the at least one app label; updating the app actions window to display one or more app-specific widgets corresponding to widgets, fields, or functions available in the second application; receiving data entered into and/or selection(s) of one or more of the one or more app-specific widgets; programmatically invoking one or more application programming interface (API) calls of the second application using the data and/or selections; receiving one or more response(s) from API call(s) to the second application; updating the workspace of the first application based upon the one or more response(s). The method enables a user's computer to access functions of a second application from within a compact window over a first application without switching context to interact with the second application in a separate window or tab.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights. © 2023 Grammarly, Inc.

### TECHNICAL FIELD

One technical field of the present disclosure is software-based control systems for invoking or launching application programs in browser-executed code, client applications, or operating systems. Another technical field is the graphical user interface control of applications.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by their inclusion in this section.

Today's business enterprises commonly employ or use knowledge workers who rely on computer program applications for productivity. Studies have shown that the average organization uses 130 applications or apps and toggles between them 1,200 times per day, leading to siloed information, inefficiencies, and constant context switching, adding unnecessary cognitive load on team members. If switching from one application to another takes two seconds, some users may spend up to five working weeks per year simply changing applications and coping with context switching.

Based on the foregoing, the referenced technical fields have developed an acute need for better technical ways for a computer user to access, enter data in, and receive output from a second program application without leaving the context of a first program application.

### SUMMARY

The appended claims may serve as a summary of the invention.

### BRIEF DESCRIPTION OF THE DRAWINGS

In the drawings:

FIG. 1A illustrates a distributed computer system showing the context of use and principal functional elements with which one embodiment could be implemented.

FIG. 1B illustrates a computer-implemented method that can be programmed as part of an embodiment.

FIG. 2A is a wireframe diagram of an example graphical user interface showing one embodiment of an app actions window.

FIG. 2B is a wireframe diagram of an example graphical user interface showing one embodiment of an app actions window and functional flows to update the window and an application workspace.

FIG. 3 is a wireframe diagram of an example graphical user interface showing one embodiment of an app actions window and functional flows to update the window and an application workspace.

FIG. 4A is a wireframe diagram of an example graphical user interface showing one embodiment of an app actions window and functional flows to update the window and an application workspace.

FIG. 4B is a wireframe diagram of an example graphical user interface showing one embodiment of an app actions window and functional flows to update the window and an application workspace.

FIG. 5 illustrates a computer system with which one embodiment could be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices described as in communication with each other need not be in continuous communication with each other unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to illustrate one or more aspects of the inventions fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or occurrences, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more inventions need not include the device itself. Techniques and mechanisms described or referenced herein will sometimes be described in singular form for clarity. However, it should be noted that particular embodiments include multiple iterations of a technique or manifestations of a mechanism unless noted otherwise. Process descriptions or blocks in figures should be understood as representing modules, segments, or portions of code, including one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 1. General Overview

Embodiments are programmed to integrate common workplace apps to enable a user to take action using a second program application using, or from within, any first program application the user is working or writing in without switching applications. Embodiments have particular utility associated with word processing, messaging, presentation, and other applications in which the user writes or revises written material. For example, while drafting or writing a document, message, or presentation, the user may need other information to contribute to the document, message, or presentation. In this context, switching applications conventionally—by clicking into a different window, launching a second application, or selecting the second application from a dock or taskbar—is especially cognitively disruptive for the user. Yet accessing the second application may be the only way to view a file, create a related task or issue, obtain an image, or retrieve other information needed in the document, message, or presentation. Therefore, enterprises have an acute need for better technical means for working teams to stay within the flow of current work without getting swept up in the swirl of constant context switching.

The method enables a user's computer to access functions of a second application from within a compact window over a first application without switching context to interact with the second application in a separate window or tab. In various embodiments, the disclosure encompasses the subject matter of the following numbered clauses:

1. A computer-implemented method executed using an assistant application and a web browser hosted or executed using a first computer, the computer-implemented method comprising receiving a first signal that first application is executing, with text within a workspace of the first application; receiving a second signal that a control was selected; instantiating and causing displaying an app actions window comprising at least one app label respectively corresponding to at least one second application; receiving input from the first computer specifying a selection of the at least one app label; updating the app actions window to display one or more app-specific widgets corresponding to widgets, fields, or functions available in the second application; receiving data entered into and/or selection(s) of one or more of the one or more app-specific widgets; programmatically invoking one or more application programming interface (API) calls of the second application using the data and/or selections; receiving one or more response(s) from API call(s) to the second application; updating the workspace of the first application based upon the one or more response(s).

2. The computer-implemented method of clause 1, comprising executing the updating, the receiving, and the programmatically invoking without changing a focus of the first computer.

3. The computer-implemented method of clause 1, comprising executing the updating, the receiving, and the programmatically invoking without instantiating a second browser window or tab for the second application.

4. The computer-implemented method of clause 1, wherein the second application is a SaaS application that is hosted using a second computer.

5. The computer-implemented method of clause 1, further comprising displaying the control as a floating control in, near, or on the workspace.

6. The computer-implemented method of clause 1, further comprising updating the app actions window to display content or confirmation data based on the one or more response(s) from the second application.

7. The computer-implemented method of clause 1, further comprising: receiving a subset of selected text from the workspace of the first application; executing an inference stage of a trained machine learning model using the subset of selected text as a prompt or context; receiving, as a response from the trained machine learning model, an app classification; instantiating and causing displaying the app actions window comprising the at least one app label wherein the app classification specifies the at least one second application.

8. The computer-implemented method of clause 1, further comprising: receiving, from the first computer, a further input specifying a further selection of a MORE control; updating the app actions window to display a plurality of other app labels corresponding to other available second applications.

9. The computer-implemented method of clause 1, wherein updating the workspace of the first application based on the one or more response(s) from the second application comprises inserting new content into the workspace of the first application based on the one or more response(s) from the second application.

### 2. Structural & Functional Overview

### 2.1 Distributed Computer System Example

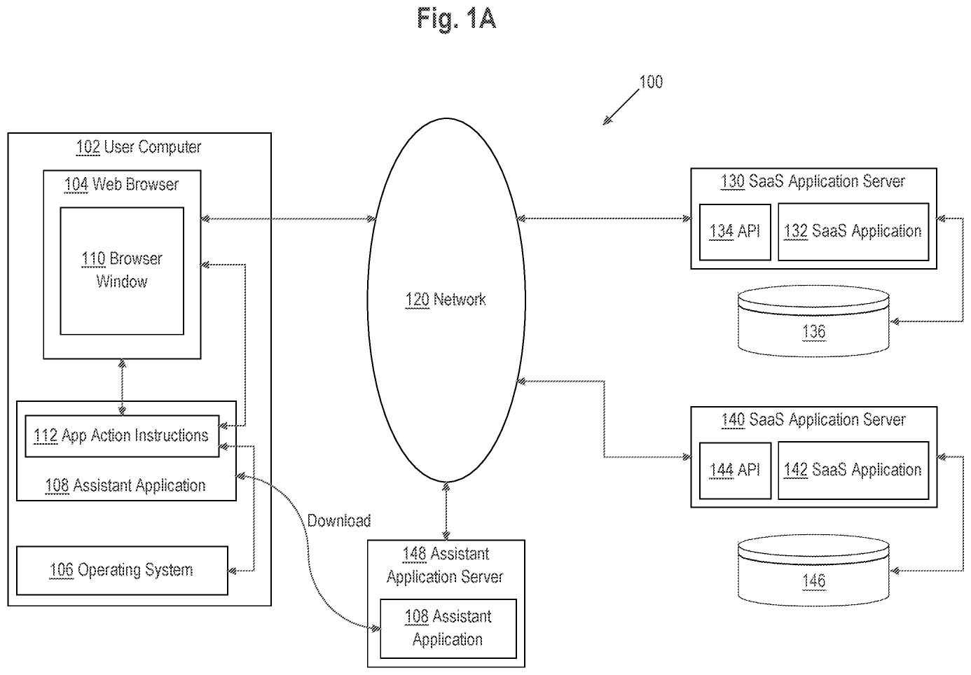

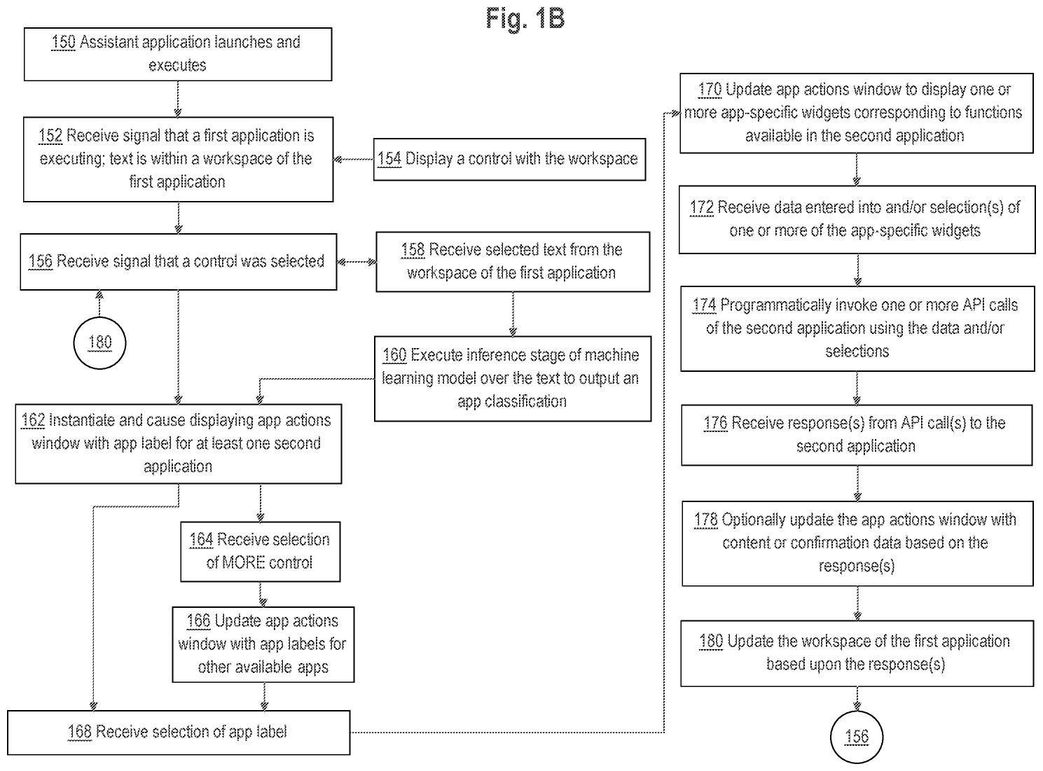

FIG. 1A illustrates a distributed computer system showing the context of use and principal functional elements with which one embodiment could be implemented. In an embodiment, a computer system 100 comprises components implemented partially by hardware at one or more computing devices, such as one or more hardware processors executing stored program instructions stored in memory for performing the functions described herein. In other words, all functions described herein are intended to indicate operations performed using programming in a special or general-purpose computer in various embodiments. FIG. 1A illustrates only one of many possible arrangements of components configured to execute the programming described herein. Other arrangements may include fewer or different components, and the division of work between the components may vary depending on the arrangement.

FIG. 1A, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of executing an action using a second program application using, or from within, any first program application that is executing, without switching applications. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In one embodiment, a user computer 102 is communicatively coupled via a network 120 to an assistant application server 148 and one or more SaaS application servers. To illustrate a clear example, two SaaS application servers 130, 140 are shown in FIG. 1A, but other embodiments may interoperate with any number of networked resources, and two servers are not required. The user computer 102 can be a laptop computer, desktop computer, workstation, network computer, tablet computer, or mobile computing device. The user computer 102 hosts or executes a web browser 104, which runs logically above and under the control of an operating system 106, which also manages the execution of an assistant application 108. The web browser 104 is programmed to instantiate in memory and render a browser window 110. In practical embodiments, any number of browser windows can be displayed. The user computer 102 can be termed a first computer, and the SaaS application servers 130, 140 can be termed second computers.

The user computer 102 can download a copy of the assistant application 108 from the assistant application server 148 and then install and launch the assistant application. The assistant application 108 can comprise app action instructions 112, which comprise sequences of stored program instructions that can be implemented as browser-executable code that executes within web browser 104 or as client-installed software that operating system 106 manages. The assistant application 108 can comprise any program application capable of monitoring input in browser window 110 and/or monitoring a document object model (DOM) of the browser window, accessing a network stack of the operating system and/or networking services of the operating system, and invoking the SaaS application servers 130, 140. Further details concerning the functions and operation of the assistant application 108 are outlined in other sections herein.

The SaaS application server 130 hosts or executes a SaaS application 132 having an application programming interface or API 134 and is communicatively coupled to a storage system 136. The API 134 exposes certain calls or functions of the application to external requests. For example, the assistant application 108 can form and transmit parameterized HTTP requests to the API 134 by specifying the API as an endpoint and including a call identifier, call parameter, and/or data for consumption at the API and SaaS application 132. After executing a substantive function in response to the call, the SaaS application 132 is programmed to transfer data for a response to the API 134, which is programmed to form an HTTP POST or GET request to convey a structured, parameterized response to the assistant application 108. The storage system 136 can comprise a flat file system, relational database, no-SQL database, object store, or other data repository, as needed to support the substantive functions of the SaaS application server 130.

The SaaS application server 140 is structured similarly and hosts or executes a SaaS application 142 having an application programming interface or API 144 and communicatively coupled to a storage system 146. The API 144 exposes certain calls or functions of the application to external requests. For example, the assistant application 108 can form and transmit parameterized HTTP requests to the API 144 by specifying the API as an endpoint and including a call identifier, call parameter, and/or data for consumption at the API and SaaS application 142. After executing a substantive function in response to the call, the SaaS application 142 is programmed to transfer data for a response to the API 144, which is programmed to form an HTTP POST or GET request to convey a structured, parameterized response to the assistant application 108. The storage system 146 can comprise a flat file system, relational database, no-SQL database, object store, or other data repository, as needed to support the substantive functions of the SaaS application server 140.

Each of the SaaS application servers 130, 140 implements a different substantive function. Example functions include cloud-based data storage, document management, calendar management, issue tracking, task management, and project or timeline management. Commercial examples of applications that the SaaS application servers 130, 140 can provide include GOOGLE DRIVE, ASANA, JIRA, CONFLUENCE, CALENDLY, UNSPLASH, GIPHY, SMARTSHEET, TRELLO, SALESFORCE, HUBSPOT, ONE DRIVE, and so forth, but none of the foregoing is required, and other embodiments can integrate and interoperate with other apps.

### 2.2 Example Data Processing Flows

FIG. 1B illustrates a computer-implemented method that can be programmed as part of an embodiment. FIG. 1B and each other flow diagram herein are intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

In general, FIG. 1B is intended to describe functions the assistant application 108 executes, but some aspects could be executed using other functional elements. In an embodiment, at block 150, an assistant application launches and executes. For example, the assistant application 108 can launch and execute. The assistant application of block 150 can comprise any program application capable of monitoring input in a browser window and/or monitoring the DOM of the browser window, accessing a network stack of the operating system and/or networking services of the operating system, and invoking networked resources such as SaaS applications.

Block 152 comprises receiving a signal that the first application is executing. Typically, the first application will have text, content, or other work represented in digital form within a virtual, visual, graphical workspace of the first application. For example, the assistant application 108 can be programmed to call a service of the operating system 106 to determine the screen coordinates of the then-current foreground window and determine if the foreground window comprises a text entry control. “Foreground,” in this context, refers to a window with present or then-current input focus during a programmatic check. Or, the assistant application 108 can install a hook to an event of the web browser 104 that publishes or signals the initiation of a communication session between the web browser and a networked application, such as one of the SaaS applications 132, 142. Or, the event can signal that the DOM of the browser window 110 comprises a workspace, text entry widget, or any other interactive element with which the user computer 102 can create, update, or delete text, select items using a pointing device or using the keyboard, or otherwise interact with the workspace to add or change content. For example, calling SetWindowsHookEx can be used with the WH_CBT hook to run a function whenever a window is created or activated.

At block 154, the process is programmed to display a control. For example, in response to detecting at block 152 that the DOM includes a workspace, the process is programmed to generate and display a control that appears in, over, or near the workspace. In an embodiment, block 154 comprises instantiating and causing displaying a floating control using a borderless window using a Region to define a non-rectangular client area. The floating control can comprise an icon, widget, or other visual representation of a control, logo, label, or other visual element capable of selection to cause other actions to occur. While a floating control has benefits, the use of a floating control is not required in all embodiments. Alternatively, the assistant application 108 could be programmed to implement control using a right-click menu, an icon, or control in a non-floating, fixed position or a window with borders or no borders in a fixed screen position.

At block 156, the process is programmed to receive a signal that a control was selected. In an embodiment, block 156 is programmed to detect a mouse event or other pointing device event for which the cursor coordinates are within the borderless window that contains the control of block 154.

The functions of block 158 and block 160 of FIG. 1B are optional and can operate to provide particular functionality as further described in connection with the wireframe drawings herein. At block 158, the process is programmed to receive, optionally, selected text from the workspace of the first application. For example, if the user computer 102 has provided input to select or highlight one or more text elements within the workspace, the contents of such text can be useful in other functions of the present process, as further described. Therefore, retrieving or obtaining the highlighted or selected text can be useful. In an embodiment, block 158 is programmed to call an API of the operating system 106 or an operating system service to retrieve the text contents of the control corresponding to the workspace of the first application.

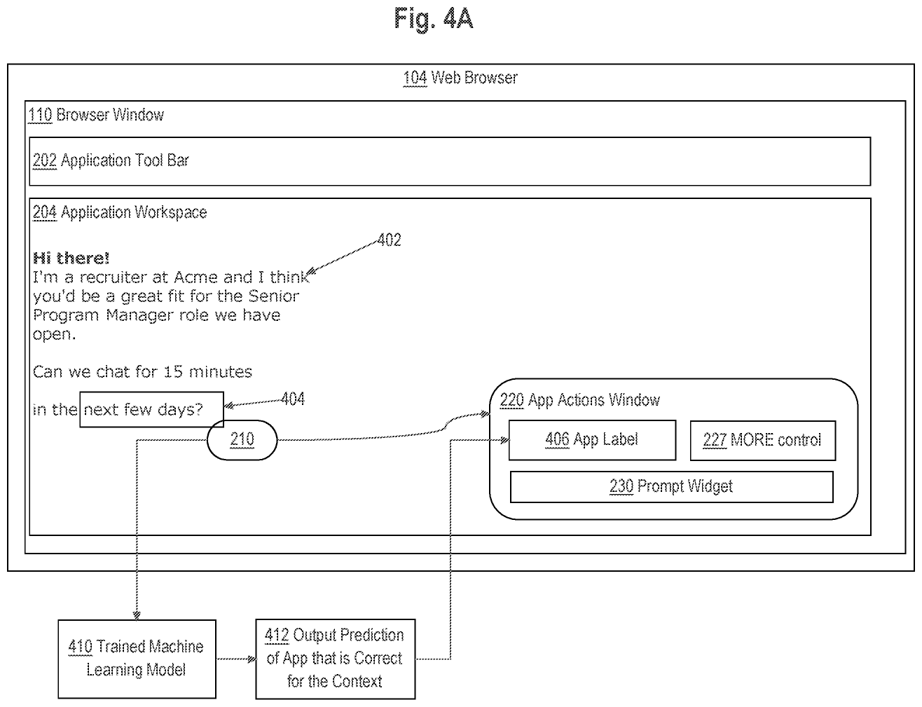

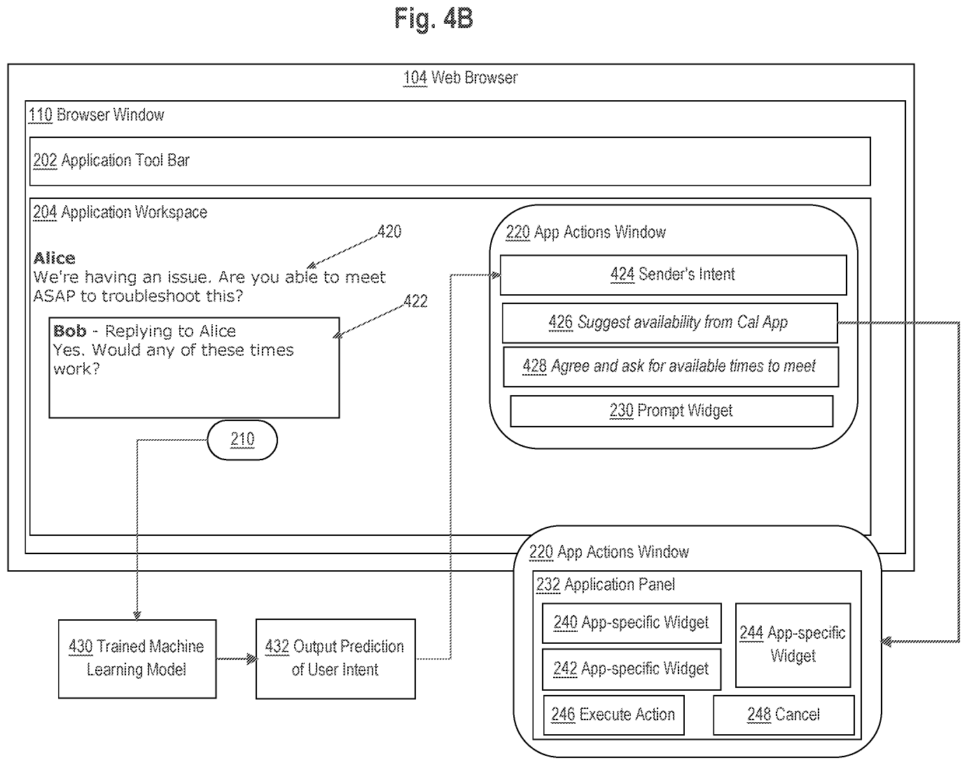

If block 158 resulted in receiving text that had been selected, then at block 160, the process is programmed to execute the inference stage of a trained machine learning model over the text to output an app classification. Functionally, block 160 determines the best match of the text received at block 158 to a particular app, corresponding to the SaaS applications 132, 142, and any other apps that are specified in configuration data available to the assistant application 108. In an embodiment, the trained machine learning model can be a linear classifier that, in response to receiving the selected text that was received at block 158, outputs a plurality of class labels and corresponding confidence values. The use of block 158 and block 160 is described further herein in connection with FIG. 4A.

At block 162, the process is programmed to instantiate and cause displaying an app actions window with an app label corresponding to at least one second application. In an embodiment, block 162 is programmed to display a window in the browser window 110 near, over, or replacing the floating control. The app actions window comprises a plurality of interactive widgets, at least one of which comprises a label that names a second application respectively corresponding to that label, such as one of the SaaS applications 132, 142.

The app actions window can include any number of app labels that correspond to different apps that are specified in configuration data available to the assistant application 108. Or, the app actions window can show a limited number of app labels, such as one to three app labels, and a widget or control labeled MORE. In an embodiment, optionally, the process is programmed to receive a selection of the MORE control and, in response, at block 166, to update the app actions window with app labels for one or more other available apps based on the configuration data. Updating at block 166 can comprise expanding, changing content, or replacing the app actions window with a different app actions window having different content. In this manner, the app actions window can initially display a limited number of app labels and then automatically update to display other labels for more available apps alone or in addition to the original labels that were shown.

At block 168, the process is programmed to receive a selection of an app label. Block 168 can comprise detecting that user computer 102 has entered input to select a particular app label within the app actions window and to determine, based on the screen coordinates of the selection, which app corresponds to the selected app label.

In response, at block 170, the process is programmed to update the app actions window to display one or more app-specific widgets corresponding to functions in the second application. In this context, updating can comprise replacing or rewriting the app actions window to remove the app labels and other content and display or write one or more app-specific widgets. Examples of widgets can include text entry boxes, numeric data entry fields, pull-down menus, radio buttons, virtual toggle switches, and/or any other app-specific function buttons. Each of the widgets corresponds to a widget or function that is available in the second application. However, the app actions window does not show, contain, or frame a web page that the second application would have generated in ordinary operation; instead, the app actions window shows app-specific widgets that correspond to widgets or functions of the second application and have a number, ordering, arrangement, and visual appearance specific to the app actions window and/or determined by a developer or coder of the app actions window. The app actions window thus can be imitative of a web page that the second application would have generated in the ordinary operation, but different in size, color, appearance, number of widgets, arrangement of widgets, and labeling of widgets.

Block 170 can be programmed to display any number of app-specific widgets in the app actions window. In one embodiment, block 170 is programmed to display fewer app-specific widgets in the app actions window than all widgets or functions that are available in the second application. Thus, the app actions window can display app-specific widgets for only a subset of all widgets or functions that otherwise would be available in the second application if the web browser 104 connected to the second application conventionally and displayed a web page that the second application had generated. The number, type, position, and appearance of the app-specific widgets that appear in the app actions window can be hard coded as part of the assistant application 108, expressed as data in configuration data, or dynamically stored in data storage that the assistant application can access. Alternatively, the assistant application 108 can be programmed to read all data available in the window that has the current focus, execute the inference stage of a trained machine learning model over that data or use that data as a prompt and/or context, and determine the number, type, position, and appearance of the selectable widgets that appear in the app actions window based upon responses from the machine learning model.

In this manner, functionally, the app-specific widgets shown in the app actions window enable the user computer 102 to enter data for, access, or use the second application from within the app actions window without switching the context to the second application in its native format. That is, the user computer 102 is not required to perform a context switch to the second application because the app actions window displays, within the same browser window 110 of the first application, all or a subset of the widgets and controls that would otherwise be available in the second application.

At block 172, the process is programmed to receive data entered into and/or selection(s) of one or more of the app-specific widgets. For example, the user computer 102 may provide text, numeric values, or selections of the app-specific widgets, and in block 172, the assistant application 108 programmatically receives those values in memory. At block 174, the process is programmed to programmatically invoke one or more API calls of the second application using the data and/or selections that were received. For example, block 174 can comprise the assistant application 108, forming a parameterized HTTP request that invokes an API call of the SaaS application 132 and includes as parameters one, several, or all the data values received at block 172 via the app-specific widgets. The request is transmitted to the specific second application that corresponds to the app label that was selected at block 168 and the app-specific widgets that have been previously shown in the app actions window.

At block 176, the process is programmed to receive one or more response(s) from the API call(s) to the second application. For example, the assistant application 108 can implement a headless browser or other programming functionality that is capable of receiving one or more parameterized HTTP responses from the second application in response to the calls that were transmitted at block 174. The responses comprise the same responsive data that the second application would have generated if the web browser 104 had been interacting with web pages that the second application natively would generate.

Based on the responses, the assistant application 108 can be programmed to execute several different actions. For example, the assistant application 108 can be programmed to close the app actions window; this could occur when the data entered at block 172 and the calls at block 174 cause the second application to create, update, or delete a database record. For example, if the second application is an issue tracking system and the app-specific widgets are programmed to receive data to define an issue to be stored in the issue tracking system, then executing the calls at block 174 could result in storing the issue and receiving a confirmation or completion response from the second application. In that case, the assistant application 108 can close the app actions window because the action associated with the app actions window and the app-specific widgets is complete. As another example, at block 178, the assistant application 108 can be programmed to update the app actions window with content or confirmation data based on the response(s). For example, the calls to the second application could cause a response from the second application that comprises text, graphics, or other data that a user associated with user computer 102 must review and approve before a final action of the second application can occur. That content and a request for confirmation could be displayed in the app actions window at block 178, with a further app-specific widget labeled CONFIRM or SUBMIT or the equivalent. In response to an input selecting that widget, the assistant application 108 can be programmed to invoke another API call of the second application to transmit a confirmation request.

Additionally, or alternatively, at block 180, the process can be programmed to update the workspace of the first application based on the response(s). Updating can comprise any operation among the following: inserting content into the workspace, inserting hyperlinks into the workspace, inserting a digital image into the workspace, and removing and replacing content in the workspace. In an embodiment, after block 180, control transfers to block 156, in effect causing the process to wait for or detect another invocation of the floating control and execute, for that invocation, the same process as previously described.

### 2.3 Graphical User Interface Examples

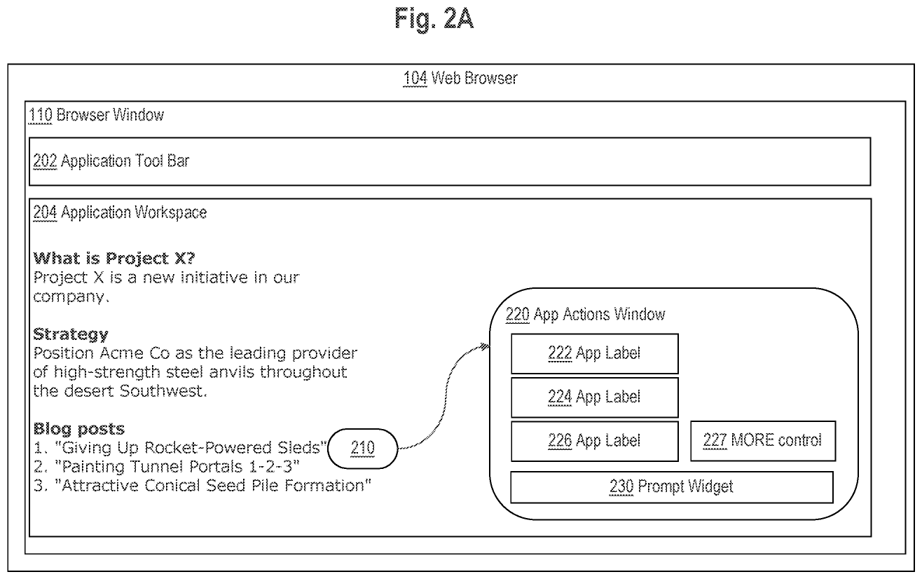

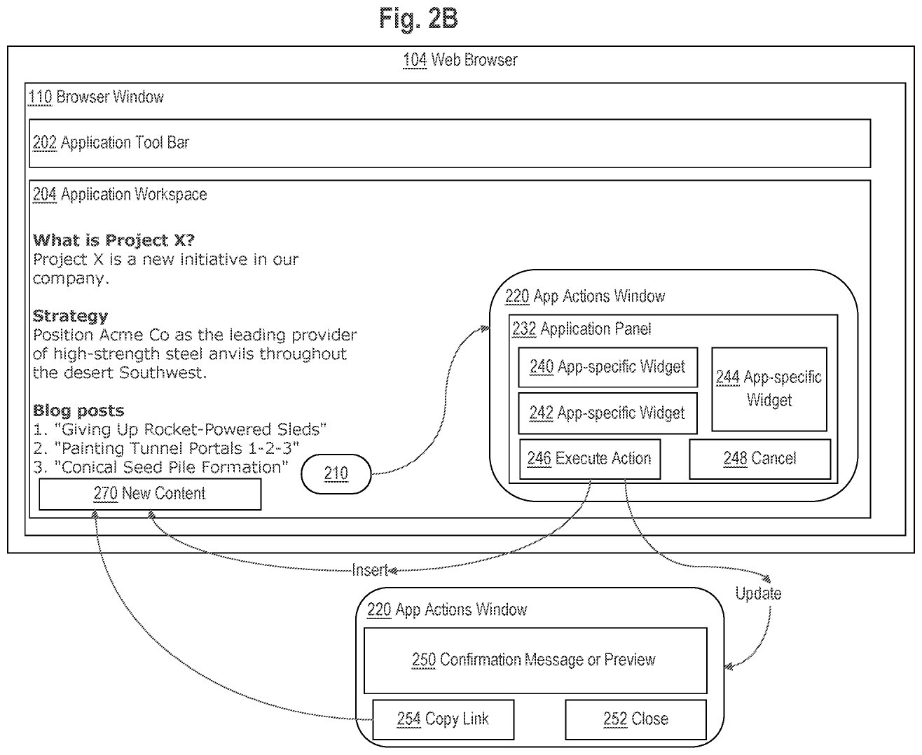

FIG. 2A is a wireframe diagram of an example graphical user interface showing one embodiment of an app actions window. In an embodiment, web browser 104 displays a browser window 110 having an application toolbar 202 and an application workspace 204. A first application, to which the web browser 104 is connected, is associated with and generates the application toolbar 202 and the application workspace 204. Thus, the application toolbar 202 and the application workspace 204 represent the first application with which the user computer 102 interacts. In some cases, the first application could be one of the SaaS applications 132, 142, and in that case, each different SaaS application that the web browser 104 accesses will determine the specific form and content of the application toolbar 202 and the application workspace 204 by generating dynamic HTML and delivering the HTML to the browser for rendering.

Assume, for purposes of illustrating one example, that the first application is a document editing application. For example, a cloud-based document editor like GOOGLE DOCS could be used. Assume further that the text shown in FIG. 2A, with the headings “What is Project X?”, “Strategy,” and “Blog posts” is the text that the user computer 102 has entered in the application workspace 204 using the first application. In an embodiment, as described above for FIG. 1B, block 154, a floating control 210 is displayed in the application workspace and can be at the position of the most recent text entry or selection of the user computer 102 or anywhere else in the application workspace 204 that the end user will likely see or notice.

In an embodiment, at any time while using the first application, the user computer 102 can click on or otherwise select the floating control 210. In response, the assistant application 108 is programmed to instantiate and cause rendering an app actions window 220 in or over the application workspace. Existing window control calls, services, or functions of the operating system 106 can be called or invoked to create the app actions window 220. In an embodiment, the app actions window 220 comprises one or more selectable graphical user interface widgets, each having a text label that identifies a corresponding second application. The example of FIG. 2A shows three selectable widgets denoted by app label 222, app label 224, and app label 226, but other embodiments can have any number of such widgets.

The number, type, position, and appearance of the selectable widgets that appear in the app actions window, such as app label 222, app label 224, and app label 226, can be hard-coded as part of the assistant application 108, expressed as data in configuration data, or dynamically stored in data storage that the assistant application can access.

In an embodiment, app actions window 220 further comprises a prompt widget 230 that is programmed as a text entry box and linked to the code of the assistant application 108, capable of processing text entered in the box as a prompt for a trained machine learning model. For example, assistant application 108 can be programmed to detect the entry of text in the prompt widget 230 and to execute the inference stage of a trained machine learning model over the text, receive a response from the machine learning model, and post-process the response and present further information based on the response in the app actions window.

Assume that user computer 102 provides input to select app label 222 in FIG. 2A. In response, the assistant application 108 is programmed to update the app actions window to display app-specific user interface elements corresponding to some or all of the functions that are available in a second application that corresponds to the selected app label. FIG. 2B is a wireframe diagram of an example graphical user interface showing one embodiment of an app actions window and functional flows to update the window and an application workspace. As shown in FIG. 2B, selection of the app label 222 of FIG. 2A has caused the assistant application 108 to update the app actions window 220 to display an application panel 232 for a second application. The second application could be one of the SaaS applications 132, 142, or another application. The application panel 232 comprises one or more app-specific widgets, for example, app-specific widget 240, app-specific widget 242, and app-specific widget 244. Examples of app-specific widgets include a graphical button, a set of radio buttons, a toggle switch, a pull-down menu, a checkbox, a date selection panel, a text entry box, a text display widget such as a preview display, a search box, a file browsing dialog or panel, an image gallery, and a slider, but others could be used.

The size, color, appearance, type, and contents of these widgets will vary according to the native interface elements and functions of the second application. The number, type, position, and appearance of the app-specific widgets that appear in the app application panel 232 can be hard-coded as part of the assistant application 108, expressed as data in configuration data, or dynamically stored in data storage that the assistant application can access. Alternatively, the assistant application 108 can be programmed to read all data available in the window that has the current focus, execute the inference stage of a trained machine learning model over that data or use that data as a prompt and/or context, and determine the number, type, position, and appearance of the selectable widgets that appear in the app actions window based upon responses from the machine learning model.

Furthermore, the assistant application 108 can be programmed to read all data available in the window that has the current focus, execute the inference stage of a trained machine learning model over that data or use that data as a prompt and/or context, and determine the one or more specific data values to populate into the app-specific widgets of the app actions window 220 based upon responses from the machine learning model. For example, if the first application is a document preparation or word processing application, and the user computer 102 has entered a portion of text that semantically specifies action items for a project, a trained machine learning model could determine that the second application should be a task management application and that specific text associated with the action items should be copied from the workspace of the first application into fields of app-specific widgets of the task management application. The assistant application 108 can be programmed to use the responses from the trained machine learning model to update the app actions window 220 with an application panel 232 for the task management application, one or more app-specific widgets corresponding to widgets or fields for functions of the task management application, and pre-populate values in those widgets or fields.

User computer 102 can select or provide input data to any one or more of app-specific widget 240, app-specific widget 242, and app-specific widget 244 at any time, causing the web browser 104 to store values in memory transiently. In an embodiment, the application panel 232 further comprises an execute action widget 246 and a cancel widget 248. Input from the user computer 102 to select the cancel widget 248 causes the assistant application 108 to close the app actions window 220. Input from the user computer 102 to select the execute action widget 246 causes the assistant application 108 to read the data values that have been entered, form a parameterized call to the second application, and transmit the call with the data values as parameters over the network to cause the second application to execute a particular function. For example, the assistant application 108 can transmit a parameterized HTTP request via network 120 to SaaS application server 130, where SaaS application 132 is the second application. In this manner, the user computer 102 can interact with a first application in the application workspace 204 and invoke functions of the second application by selecting or entering data in the app actions window 220 without opening a new browser window or tab for the second application and thus maintaining context and focus on the application workspace of the first application.

In one embodiment, executing the action in the foregoing manner causes the second application to send a response comprising new content to the assistant application 108, which can be programmed to insert the new content 270 into the DOM of the browser window 110, thus causing the new content to appear in the application workspace 204. The assistant application 108 can be programmed to provide different screen coordinates for the new content 270 than the position of the floating control 210, or the assistant application can present the new content at or near the same coordinates or position of focus that existed at the time of selecting the floating control.

In an embodiment, input from user computer 102 to select the execute action widget 246 causes the second application to return a confirmation message or a response that requires confirmation or other presentation of content to the user computer before an update to the application workspace 204 can occur. For example, the response from the second application could contain data and a request for the user computer 102 to confirm that the data is correct or that a particular action should be taken. The assistant application 108 can be programmed to inspect the response, determine that confirmation is needed, and update the app actions window 220 to remove or clear the application panel 232 and present a confirmation message 250 as the complete contents of the app actions window. Alternatively, the confirmation message 250 can be presented within the application panel 232, replacing the app-specific widgets 240, 242, 244. The confirmation message 250 can comprise substantive content from the second application rather than a notification, alert, prompt, or other message. In another alternative, the confirmation message 250 comprises content that confirms that the second application executed or completed a requested action in response to the selection or use of the app-specific widgets. For example, when the second application is a task management system, the confirmation message 250 could state, “Task created.”

Furthermore, the execute action widget 246 and the cancel widget 248 can be removed and/or replaced with different widgets, such as a close widget 252 and a copy link widget 254. Input from user computer 102 to select the close widget 252 causes closing the app actions window 220 without further action. Input from user computer 102 to select the copy link widget 254 causes the assistant application to copy the confirmation message 250 to a buffer memory space, from which the message can be pasted into the application workspace 204 at a position that the user computer selects via other input within the application workspace.

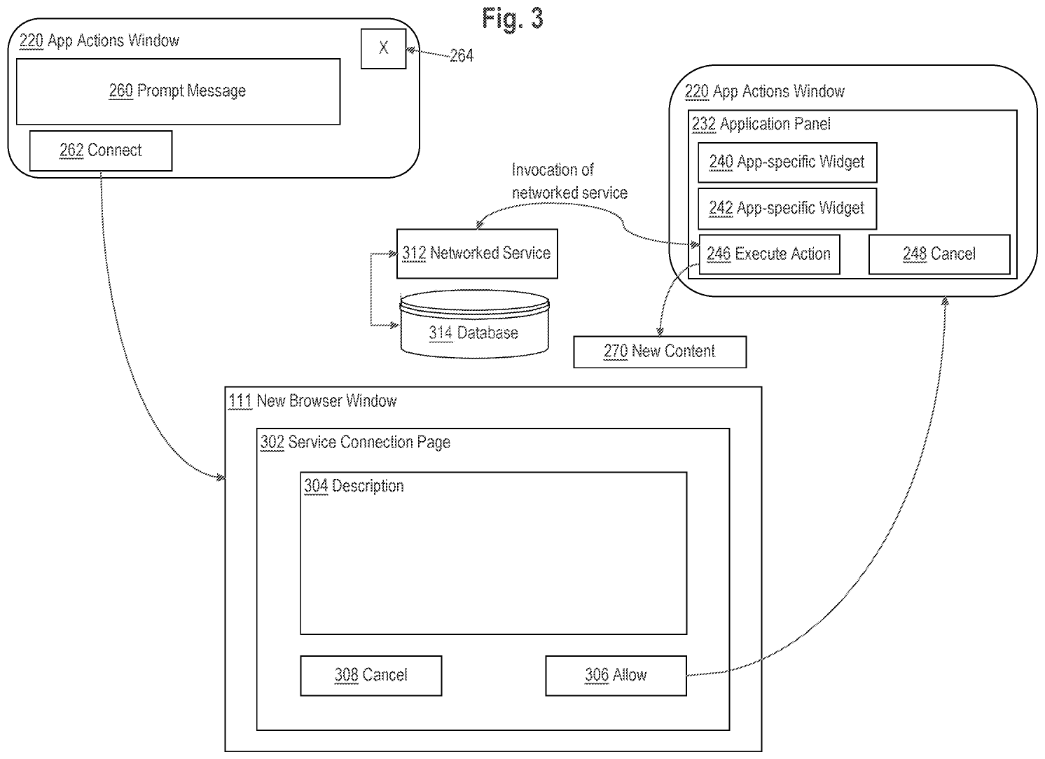

In some cases, the second application may require the user computer 102 to create an account, link an account, present security credentials, log in to a server, or perform other actions. In an embodiment, the assistant application 108 is programmed to facilitate these interactions with the second application. FIG. 3 is a wireframe diagram of an example graphical user interface showing one embodiment of an app actions window and functional flows to update the window and an application workspace. In the example of FIG. 3, assume that the same operations have occurred as described for FIG. 2B. The app actions window 220 of FIG. 3 has been updated to show a prompt message 260 and a connect widget 262. In this case, the response from the second application comprises prompt text indicating that the user computer 102 must link an account to the second application. The assistant application 108 is programmed to detect such a response, cause displaying the prompt message 260, and to display the connect widget 262 and a window close widget 264.

In an embodiment, input from user computer 102 to select the connect widget 262 causes the assistant application 108 to instantiate and cause the web browser 104 to render a new browser window 111 and to connect the new browser window to a service connection page 302 of the second application. The service connection page 302 can comprise a description, an allow widget 306, and a cancel widget 308. Input from the user computer 102 to select the allow widget 306 causes the web browser 104 to transmit an HTTP POST request to the second application, which executes local processing to allow a connection or linkage of a user account to the second application.

Further, the assistant application 108 is programmed to cause the web browser 104 to close the new browser window 111; at that point, the browser window 110 appears like FIG. 2B, in which the app actions window 220 remains available, and the user computer 102 can interact with or request actions of the second application through the app actions window. At that point, for example, selecting the execute action widget 246 could cause the assistant application 108 to request an invocation of a networked service 312, resulting in generating new content 270, updating a database 314, or taking another action.

Input from the user computer 102 to select the cancel widget 308 causes closing the new browser window 111. In an embodiment, the creation of a new browser window 111 to facilitate a connection to a secure second application occurs only once, and thereafter, the user computer 102 can access the second application in the manner previously described via app actions window 220 over the application workspace 204 of the first application, in the browser window 110.

FIG. 4A is a wireframe diagram of an example graphical user interface showing one embodiment of an app actions window and functional flows to update the window and an application workspace. In an embodiment, as with prior examples, web browser 104 displays a browser window 110 having an application toolbar 202 and application workspace 204 associated with a first application. In the example of FIG. 4A, the first application is a SaaS-based e-mail application, and the user computer 102 has entered body text 402 of an e-mail message in the application workspace 204.

Input from user computer 102 selects a text subset 404 from within the body text 402. Input from user computer 102 then selects the floating control 210. In an embodiment, the assistant application 108 is programmed, in response to input from the user to select the floating control 210, to instantiate and cause displaying the app actions window 220, and concurrently to execute the inference stage of a trained machine learning model 410 over the text subset 404. For example, the assistant application 108 can call an API, method, or other programmatic mechanism to access the trained machine learning model 410 and provide the text subset 404 in the call or method invocation. In response, the trained machine learning model 410 generates and programmatically returns an output prediction 412 of an app that is correct for the context.

The trained machine learning model 410 can be a classifier that has been trained based on a training dataset consisting of data pairs having a text string and an application identifier from among a finite set of configured application identifiers for specific second applications. Thus, there could be five, ten, twenty, or some other number of second applications with which the assistant application 108 is compatible and capable of rendering an app actions window 220, and all training data comprises text strings labeled with identifiers of one of those second applications. In this embodiment, presuming one of the second applications is a calendar scheduling application, executing the inference stage over “next few days” could classify that text as relating to calendar scheduling, so the output prediction 412 would comprise an identifier of the calendar scheduling application and a confidence level value.

In an embodiment, if the confidence level value exceeds a programmed threshold value, then the assistant application 108 is programmed to update the app actions window 220 with a selectable widget comprising app label 406 and identifying the calendar scheduling application. If the confidence level does not exceed the programmed threshold value, then the assistant application 108 is programmed to update the app actions window 220 with a plurality of app labels identifying all the configured second applications; for example, three or more app labels could be shown, as in FIG. 2A. Referring again to FIG. 4A, in an embodiment, a MORE control 227 and the prompt widget 230 can also be provided in the app actions window 220. Input from user computer 102 to select the app label 406 causes the assistant application 108 to update the app actions window 220 to show an application panel 232 having one or more app-specific widgets for the calendar scheduling application, as generally described above for FIG. 3.

FIG. 4B is a wireframe diagram of an example graphical user interface showing one embodiment of an app actions window and functional flows to update the window and an application workspace. In an embodiment, as with prior examples, web browser 104 displays a browser window 110 having an application toolbar 202 and application workspace 204 associated with a first application. In the example of FIG. 4B, the first application is an instant messaging application, and the user computer 102 has received a first message 420 from another user, “Alice,” and is composing a second message 422 in the application workspace 204. As “Bob” works on the response message, the assistant application 108 displays the floating control 210 near the second message 422. In an embodiment, the assistant application 108 is programmed to read all text that is available in the window of current focus, namely application workspace 204, and submit the text as a prompt and/or context to a trained machine learning model 430. After executing the inference stage over the prompt and/or context, the trained machine learning model 430 generates an output prediction of user intent 432. Public large language model (LLM) APIs can be called to generate a user intent prediction. Based on the specific text examples in FIG. 4B, the output prediction of user intent 432 might be, “The sender is requesting to schedule. It seems urgent.”

In an embodiment, the assistant application 108 is programmed to instantiate and cause displaying the app actions window 220 in or over the application workspace 204. In the example of FIG. 4B, the app actions window 220 comprises a sender's intent widget 424, one or more suggested action widgets 426, 428, and a prompt widget 230. In an embodiment, the assistant application 108 is programmed to populate the sender's intent widget 424 with text corresponding to the sender's intent based on the output prediction of user intent 432. Furthermore, the assistant application 108 is programmed to determine labels and connections to second applications for the one or more suggested action widgets 426, 428 based on the output prediction of user intent 432. For example, based on the specific text examples in FIG. 4B, and the output prediction of user intent 432, the assistant application 108 is programmed to generate action widgets 426, 428 with the labels “Suggest availability from Calendar Application” and “Agree and ask for available times to meet.”

Further, the assistant application 108 is programmed to associate the action widget 426 with a second application, namely the calendar application, and to associate the action widget 428 with a snippet of text. In response to input from user computer 102 to select the action widget 426, the assistant application 108 is programmed to replace and/or update the app actions window 220 with an application panel 232 as shown in FIG. 4B, with one or more app-specific widgets 240, 242, 244 corresponding to widgets, fields, or functions of the calendar application. As with prior examples, the calendar application could comprise SaaS application 132 or SaaS application 142 (FIG. 1A). In response to input from user computer 102 to select the action widget 428, the assistant application 108 is programmed to copy the snippet of text to a buffer; the user computer then can provide input to signal to paste the snippet of text into the second message 422. In this manner, the trained machine learning model 430 facilitates more efficient connections to the correct or best second application, which can be accessed via app actions window 220 without a context switch away from the application workspace 204. Furthermore, the trained machine learning model 430 facilitates more efficient, automatic generation of text that is likely to be useful in the application workspace 204.

### 3. Implementation Example—Hardware Overview

According to one embodiment, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. To accomplish the described techniques, such computing devices may combine custom hard-wired logic, ASICs, or FPGAs with custom programming. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

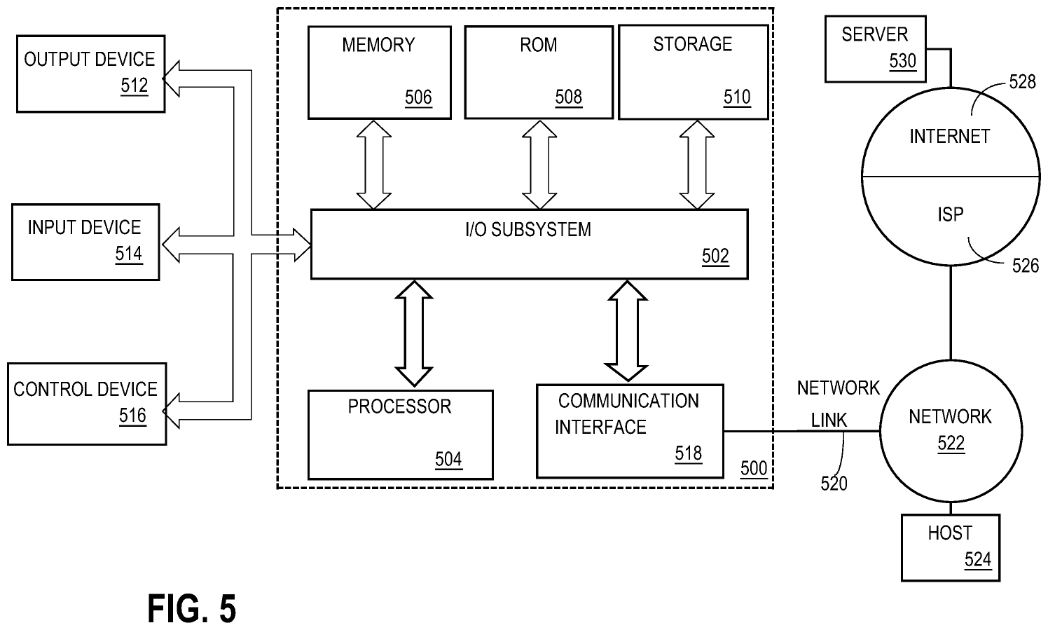

FIG. 5 is a block diagram that illustrates an example computer system with which an embodiment may be implemented. In the example of FIG. 5, a computer system 500 and instructions for implementing the disclosed technologies in hardware, software, or a combination of hardware and software are represented schematically, for example, as boxes and circles, at the same level of detail that is commonly used by persons of ordinary skill in the art to which this disclosure pertains for communicating about computer architecture and computer systems implementations.

Computer system 500 includes an input/output (I/O) subsystem 502, which may include a bus and/or other communication mechanism(s) for communicating information and/or instructions between the components of the computer system 500 over electronic signal paths. The I/O subsystem 502 may include an I/O controller, a memory controller, and at least one I/O port. The electronic signal paths are represented schematically in the drawings, such as lines, unidirectional arrows, or bidirectional arrows.

At least one hardware processor 504 is coupled to I/O subsystem 502 for processing information and instructions. Hardware processor 504 may include, for example, a general-purpose microprocessor or microcontroller and/or a special-purpose microprocessor such as an embedded system, a graphics processing unit (GPU), or a digital signal processor or ARM processor. Processor 504 may comprise an integrated arithmetic logic unit (ALU) or be coupled to a separate ALU.

Computer system 500 includes one or more units of memory 506, such as a main memory, coupled to I/O subsystem 502 for electronically digitally storing data and instructions to be executed by processor 504. Memory 506 may include volatile memory such as various forms of random-access memory (RAM) or other dynamic storage device. Memory 506 may also be used for storing temporary variables or other intermediate information during the execution of instructions to be executed by processor 504. Such instructions, when stored in non-transitory computer-readable storage media accessible to processor 504, can render computer system 500 into a special-purpose machine customized to perform the operations specified in the instructions.

Computer system 500 includes non-volatile memory such as read-only memory (ROM) 508 or other static storage devices coupled to I/O subsystem 502 for storing information and instructions for processor 504. The ROM 508 may include various forms of programmable ROM (PROM), such as erasable PROM (EPROM) or electrically erasable PROM (EEPROM). A unit of persistent storage 510 may include various forms of non-volatile RAM (NVRAM), such as FLASH memory, solid-state storage, magnetic disk, or optical disks such as CD-ROM or DVD-ROM and may be coupled to I/O subsystem 502 for storing information and instructions. Storage 510 is an example of a non-transitory computer-readable medium that may be used to store instructions and data which, when executed by the processor 504, cause performing computer-implemented methods to execute the techniques herein.

The instructions in memory 506, ROM 508, or storage 510 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation, application, and data storage layer, such as a relational database system using a structured query language (SQL) or no SQL, an object store, a graph database, a flat file system, or other data storage.

Computer system 500 may be coupled via I/O subsystem 502 to at least one output device 512. In one embodiment, output device 512 is a digital computer display. Examples of a display that may be used in various embodiments include a touchscreen display, a light-emitting diode (LED) display, a liquid crystal display (LCD), or an e-paper display. Computer system 500 may include other type(s) of output devices 512, alternatively or in addition to a display device. Examples of other output devices 512 include printers, ticket printers, plotters, projectors, sound cards or video cards, speakers, buzzers or piezoelectric devices or other audible devices, lamps or LED or LCD indicators, haptic devices, actuators or servos.

At least one input device 514 is coupled to I/O subsystem 502 for communicating signals, data, command selections, or gestures to processor 504. Examples of input devices 514 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. The control device 516 may be a touchpad, a mouse, a trackball, or cursor direction keys for communicating direction information and command selections to processor 504 and for controlling cursor movement on an output device 512, such as a display. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other control device. An input device 514 may include a combination of multiple input devices, such as a video camera and a depth sensor.

In another embodiment, computer system 500 may comprise an Internet of Things (IoT) device in which one or more of the output device 512, input device 514, and control device 516 are omitted. Or, in such an embodiment, the input device 514 may comprise one or more cameras, motion detectors, thermometers, microphones, seismic detectors, other sensors or detectors, measurement devices or encoders, and the output device 512 may comprise a special-purpose display such as a single-line LED or LCD display, one or more indicators, a display panel, a meter, a valve, a solenoid, an actuator or a servo.

When computer system 500 is a mobile computing device, input device 514 may comprise a global positioning system (GPS) receiver coupled to a GPS module that is capable of triangulating to a plurality of GPS satellites, determining and generating geo-location or position data such as latitude-longitude values for a geophysical location of the computer system 500. Output device 512 may include hardware, software, firmware, and interfaces for generating position reporting packets, notifications, pulse or heartbeat signals, or other recurring data transmissions that specify a position of the computer system 500, alone or in combination with other application-specific data, directed toward host computer 524 or server computer 530.

Computer system 500 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 500 in response to processor 504 executing at least one sequence of at least one instruction contained in main memory 506. Such instructions may be read into main memory 506 from another storage medium, such as storage 510. Execution of the sequences of instructions contained in main memory 506 causes processor 504 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct but may be used with transmission media. Transmission media participates in transferring information between storage media. For example, transmission media includes coaxial cables, copper wire and fiber optics, and wires comprising a bus of I/O subsystem 502. Transmission media can also be acoustic or light waves generated during radio-wave and infrared data communications.

Various forms of media may carry at least one sequence of at least one instruction to processor 504 for execution. For example, the instructions may initially be carried on a remote computer's magnetic disk or solid-state drive. The remote computer can load the instructions into its dynamic memory and send them over a communication link such as a fiber optic, coaxial cable, or telephone line using a modem. A modem or router local to computer system 500 can receive the data on the communication link and convert the data to a format that can be read by computer system 500. For instance, a receiver such as a radio frequency antenna or an infrared detector can receive the data carried in a wireless or optical signal, and appropriate circuitry can provide the data to I/O subsystem 502, such as placing the data on a bus. I/O subsystem 502 carries the data to memory 506, from which processor 504 retrieves and executes the instructions. The instructions received by memory 506 may optionally be stored on storage 510 before or after execution by processor 504.

Computer system 500 also includes a communication interface 518 coupled to a bus or I/O subsystem 502. Communication interface 518 provides a two-way data communication coupling to a network link(s) 520 directly or indirectly connected to at least one communication network, such as a network 522 or a public or private cloud on the Internet. For example, communication interface 518 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 522 broadly represents a local area network (LAN), wide-area network (WAN), campus network, internetwork, or any combination thereof. Communication interface 518 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 518 sends and receives electrical, electromagnetic, or optical signals over signal paths that carry digital data streams representing various types of information.

Network link 520 typically provides electrical, electromagnetic, or optical data communication directly or through at least one network to other data devices, using, for example, satellite, cellular, Wi-Fi, or BLUETOOTH technology. For example, network link 520 may connect through network 522 to a host computer 524.

Furthermore, network link 520 may connect through network 522 or to other computing devices via internetworking devices and/or computers operated by an Internet Service Provider (ISP) 526. ISP 526 provides data communication services through a worldwide packet data communication network called Internet 528. A server computer 530 may be coupled to Internet 528. Server computer 530 broadly represents any computer, data center, virtual machine, or virtual computing instance with or without a hypervisor or computer executing a containerized program system such as DOCKER or KUBERNETES. Server computer 530 may represent an electronic digital service that is implemented using more than one computer or instance, and that is accessed and used by transmitting web services requests, uniform resource locator (URL) strings with parameters in HTTP payloads, API calls, app services calls, or other service calls. Computer system 500 and server computer 530 may form elements of a distributed computing system that includes other computers, a processing cluster, a server farm, or other organizations of computers that cooperate to perform tasks or execute applications or services. Server computer 530 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 530 may comprise a web application server that hosts a presentation layer, application layer, and data storage layer, such as a relational database system using a structured query language (SQL) or no SQL, an object store, a graph database, a flat file system or other data storage.

Computer system 500 can send messages and receive data and instructions, including program code, through the network(s), network link 520, and communication interface 518. In the Internet example, server computer 530 might transmit a requested code for an application program through Internet 528, ISP 526, local network 522, and communication interface 518. The received code may be executed by processor 504 as it is received and/or stored in storage 510 or other non-volatile storage for later execution.

The execution of instructions, as described in this section, may implement a process in the form of an instance of a computer program that is being executed and consists of a program code and its current activity. Depending on the operating system (OS), a process may comprise multiple threads of execution that execute instructions concurrently. In this context, a computer program is a passive collection of instructions, while a process may execute those instructions. Several processes may be associated with the same program; for example, opening up several instances of the same program often means more than one process is being executed. Multitasking may be implemented to allow multiple processes to share processor 504. While each processor 504 or core of the processor executes a single task at a time, computer system 500 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. Accordingly, the specification and drawings should be regarded in an illustrative rather than a restrictive sense. The sole and exclusive indicator of the scope of the invention, and what is intended by the applicants to be the scope of the invention, is the literal and equivalent scope of the set of claims that issued from this application in the specific form in which such claims issue, including any subsequent correction.

What is claimed is:

1. A computer-implemented method executed using an assistant application and a web browser hosted or executed using a first computer, the computer-implemented method comprising:
receiving a first signal that a first application is executing, with text within a workspace of the first application;
receiving a second signal that a control was selected;
instantiating and causing displaying an app actions window comprising at least one app label respectively corresponding to at least one second application;
receiving input from the first computer specifying a selection of the at least one app label;
updating the app actions window to display one or more app-specific widgets corresponding to widgets, fields, or functions available in the second application;
receiving data entered into and/or selection(s) of one or more of the one or more app-specific widgets;
programmatically invoking one or more application programming interface (API) calls of the second application using the data and/or selections;
receiving one or more response(s) from API call(s) to the second application;
updating the workspace of the first application based upon the one or more response(s).

2. The computer-implemented method of claim 1, comprising executing the updating, the receiving, and the programmatically invoking without changing a focus of the first computer.

3. The computer-implemented method of claim 1, comprising executing the updating, the receiving, and the programmatically invoking without instantiating a second browser window or tab for the second application.

4. The computer-implemented method of claim 1, wherein the second application is a SaaS application that is hosted using a second computer.

5. The computer-implemented method of claim 1, further comprising displaying the control as a floating control in, near, or on the workspace.

6. The computer-implemented method of claim 1, further comprising updating the app actions window to display content or confirmation data based on the one or more response(s) from the second application.

7. The computer-implemented method of claim 1, further comprising:
receiving a subset of selected text from the workspace of the first application;
executing an inference stage of a trained machine learning model using the subset of selected text as a prompt or context;
receiving, as a response from the trained machine learning model, an app classification;
instantiating and causing displaying the app actions window comprising the at least one app label wherein the app classification specifies the at least one second application.

8. The computer-implemented method of claim 1, further comprising:
receiving, from the first computer, a further input specifying a further selection of a MORE control;
updating the app actions window to display a plurality of other app labels corresponding to other available second applications.

9. The computer-implemented method of claim 1, wherein updating the workspace of the first application based on the one or more response(s) from the second application comprises inserting new content into the workspace of the first application based on the one or more response(s) from the second application.

10. The computer-implemented method of claim 1, further comprising:
based on the one or more response(s) from the second application, updating the app actions window to display a confirmation message or a preview and a copy link widget;
in response to a further input from the first computer specifying a further selection of the copy link widget, copying the confirmation message or the preview to a buffer in memory.

11. One or more non-transitory computer-readable storage media storing one or more sequences of instructions which, when executed using one or more processors, cause the one or more processors to execute, using an assistant application and a web browser hosted or executed using a first computer:
receiving a first signal that a first application is executing, with text within a workspace of the first application;
receiving a second signal that a control was selected;
instantiating and causing displaying an app actions window comprising at least one app label respectively corresponding to at least one second application;
receiving input from the first computer specifying a selection of the at least one app label;
updating the app actions window to display one or more app-specific widgets corresponding to widgets, fields, or functions available in the second application;
receiving data entered into and/or selection(s) of one or more of the one or more app-specific widgets;
programmatically invoking one or more application programming interface (API) calls of the second application using the data and/or selections;
receiving one or more response(s) from API call(s) to the second application;
updating the workspace of the first application based upon the one or more response(s).

12. The one or more non-transitory computer-readable storage media of claim 11, further comprising one or more sequences of instructions which, when executed using the one or more processors, cause the one or more processors to execute the updating, the receiving, and the programmatically invoking without changing a focus of the first computer.

13. The one or more non-transitory computer-readable storage media of claim 11, further comprising one or more sequences of instructions which, when executed using the one or more processors, cause the one or more processors to execute the updating, the receiving, and the programmatically invoking without instantiating a second browser window or tab for the second application.

14. The one or more non-transitory computer-readable storage media of claim 11, wherein the second application is a SaaS application that is hosted using a second computer.

15. The one or more non-transitory computer-readable storage media of claim 11, further comprising one or more sequences of instructions which, when executed using the one or more processors, cause the one or more processors to execute displaying the control as a floating control in, near, or on the workspace.

16. The one or more non-transitory computer-readable storage media of claim 11, further comprising one or more sequences of instructions which, when executed using the one or more processors, cause the one or more processors to execute updating the app actions window to display content or confirmation data based on the one or more response(s) from the second application.

17. The one or more non-transitory computer-readable storage media of claim 11, further comprising one or more sequences of instructions which, when executed using the one or more processors, cause the one or more processors to execute:
receiving a subset of selected text from the workspace of the first application;
executing an inference stage of a trained machine learning model using the subset of selected text as a prompt or context;
receiving, as a response from the trained machine learning model, an app classification;
instantiating and causing displaying the app actions window comprising the at least one app label wherein the app classification specifies the at least one second application.

18. The one or more non-transitory computer-readable storage media of claim 11, further comprising one or more sequences of instructions which, when executed using the one or more processors, cause the one or more processors to execute:
receiving, from the first computer, a further input specifying a further selection of a MORE control;
updating the app actions window to display a plurality of other app labels corresponding to other available second applications.

19. The one or more non-transitory computer-readable storage media of claim 11, further comprising one or more sequences of instructions which, when executed using the one or more processors, cause the one or more processors to execute updating the workspace of the first application based on the one or more response(s) from the second application by inserting new content into the workspace of the first application based on the one or more response(s) from the second application.

20. The one or more non-transitory computer-readable storage media of claim 11, further comprising one or more sequences of instructions which, when executed using the one or more processors, cause the one or more processors to execute:
based on the one or more response(s) from the second application, updating the app actions window to display a confirmation message or a preview and a copy link widget;
in response to a further input from the first computer specifying a further selection of the copy link widget, copying the confirmation message or the preview to a buffer in memory.
